(19) United States
(12) Patent Application Publication
(10) Pub. No.: US 2015/0028687 A1
(43) Pub. Date: Jan. 29, 2015

(54) POWER TRANSMITTING DEVICE, POWER RECEIVING DEVICE AND POWER TRANSFER SYSTEM

(71) Applicants: Shinji Ichikawa, Toyota-shi (JP); Toru Nakamura, Toyota-shi (JP); Masaya Ishida, Nagakute-shi (JP); Toshiaki Watanabe, Owariasahi-shi (JP); Yoshiyuki Hattori, Nagakute-shi (JP); Takashi Kojima, Nagoya-shi (JP)

(72) Inventors: Shinji Ichikawa, Toyota-shi (JP); Toru Nakamura, Toyota-shi (JP); Masaya Ishida, Nagakute-shi (JP); Toshiaki Watanabe, Owariasahi-shi (JP); Yoshiyuki Hattori, Nagakute-shi (JP); Takashi Kojima, Nagoya-shi (JP)

(73) Assignee: TOYOTA JIDOSHA KABUSHIKI KAISHA, Toyota-shi, Aichi-ken (JP)

(21) Appl. No.: 14/374,333

(22) PCT Filed: Jan. 30, 2013
(86) PCT No.: PCT/IB2013/000111

§ 371 Date: Jul. 24, 2014

(30) Foreign Application Priority Data
Feb. 6, 2012 (JP) 2012-023068

(51) Int. Cl. H02J 5/00; H01F 27/28; H01F 38/14

(52) U.S. Cl. CPC H02J 5/005; H01F 38/14; H01F 27/2885
USPC 307/104

(57) ABSTRACT

A power transmitting device includes a power transmitting portion that contactlessly transmits electric power to a power receiving portion. The power transmitting portion has a resonance coil (24) and a tubular member (240) that faces the resonance coil (24). At least one portion of the tubular member (240) is electrically cut off.

### BACKGROUND OF THE INVENTION

1. Field of the Invention

The invention relates to a power transmitting device, a power receiving device and a power transfer system.

2. Description of Related Art

In recent years, hybrid vehicles, electric vehicles, and the like, that drive drive wheels with the use of electric power from a battery, or the like, become a focus of attention in consideration of an environment.

Particularly, in recent years, in the above-described electromotive vehicles equipped with a battery, wireless charging through which the battery is contactlessly chargeable without using a plug, or the like, becomes a focus of attention. Then, various contactless charging systems have been suggested recently.

A power transfer system that uses a contactless charging system is, for example, described in Japanese Patent Application Publication No. 2011-072188 (JP 2011-072188 A), Japanese Patent Application Publication No. 2010-239848 (JP 2010-239848 A) and Japanese Patent Application Publication No. 2011-045189 (JP 2011-045189 A).

In these power transfer systems, a shield structure that reduces a leakage electromagnetic field by covering a power transmitting portion with a shield member is described. Similarly, a shield structure that reduces a leakage electromagnetic field by covering a power receiving portion with a shield member is described.

An electromagnetic field that is used in power transfer is formed of an electric field and a magnetic field. In the case where power transfer is carried out contactlessly, there is a challenge that the efficiency of power transfer deteriorates when not only an electric field but also a magnetic field is reduced by a shield member.

### SUMMARY OF THE INVENTION

The invention provides a power transmitting device, a power receiving device and a power transfer system that have a structure that is able to reduce an electric field in an electromagnetic field formed of the electric field and a magnetic field when power transfer is carried out contactlessly.

An aspect of the invention provides a power transmitting device that includes a power transmitting portion that has a coil and a shield member and that contactlessly transmits electric power to a power receiving portion, the shield member being arranged at a position such that the shield member faces the coil, and at least one portion of the shield member being electrically cut off.

In the power transmitting device, the shield member may form a tubular member that accommodates the coil inside and that has both end portions.

In the power transmitting device, the tubular member may have a hole that communicates an outside of the tubular member with the inside of the tubular member.

In the power transmitting device, the coil may be arranged on a first insulating member, the shield member may include a first shield member and a second shield member, the first shield member may be arranged on a second insulating member, the second shield member may be arranged on a third insulating member, and the coil may be sandwiched by the first shield member and the second shield member by sandwiching the first insulating member by the second insulating member and the third insulating member.

In the power transmitting device, the first insulating member, the second insulating member and the third insulating member may be insulating substrates.

In the vehicle, a difference between a natural frequency of the power transmitting portion and a natural frequency of the power receiving portion may be smaller than or equal to 10% of the natural frequency of the power receiving portion.

In the power transmitting device, a coupling coefficient between the power receiving portion and the power transmitting portion may be smaller than or equal to 0.1. In the power transmitting device, the power transmitting portion may transmit electric power to the power receiving portion through at least one of a magnetic field and an electric filed. The magnetic filed is formed between the power receiving portion and the power transmitting portion and oscillates at a predetermined frequency. The electric field is formed between the power receiving portion and the power transmitting portion and oscillates at a predetermined frequency.

Another aspect of the invention provides a power transfer system that includes: a power transmitting device that includes a power transmitting portion that has a coil and a shield member that is arranged at a position such that the shield member faces the coil, at least one portion of the shield member being electrically cut off; and a power receiving device that contactlessly receives electric power from the power transmitting portion.

In the power transfer system, the shield member may form a tubular member that accommodates the coil inside and that has both end portions.

In the power transfer system, the tubular member may have a hole that communicates an outside of the tubular member with the inside of the tubular member.

In the power transfer system, the coil may be arranged on a first insulating member, the shield member may include a first shield member and a second shield member, the first shield member may be arranged on a second insulating member, the second shield member may be arranged on a third insulating member, and the coil may be sandwiched by the first shield member and the second shield member by sandwiching the first insulating member by the second insulating member and the third insulating member.

In the power transfer system, the first insulating member, the second insulating member and the third insulating member may be insulating substrates.

Further another aspect of the invention provides a power receiving device that includes a power receiving portion that has a coil and a shield member and contactlessly receives electric power from a power transmitting portion, the shield member being arranged at a position such that the shield member faces the coil, at least one portion of the shield member being electrically cut off.

In the power receiving device, the shield member may form a tubular member that accommodates the coil inside and that has both end portions.

In the power receiving device, the tubular member may have a hole that communicates an outside of the tubular member with the inside of the tubular member.

In the power receiving device, the coil may be arranged on a first insulating member, the shield member may include a first shield member and a second shield member, the first shield member may be arranged on a second insulating member, the second shield member may be arranged on a third insulating member, and the coil may be sandwiched by the first shield member and the second shield member by sandwiching the first insulating member by the second insulating member and the third insulating member.

In the power receiving device, the first insulating member, the second insulating member and the third insulating member may be insulating substrates.

In the power receiving device, a difference between a natural frequency of the power transmitting portion and a natural frequency of the power receiving portion may be smaller than or equal to 10% of the natural frequency of the power receiving portion.

In the power receiving device, a coupling coefficient between the power receiving portion and the power transmitting portion may be smaller than or equal to 0.1. In the power receiving device, the power transmitting portion may transmit electric power to the power receiving portion through at least one of a magnetic field and an electric field. The magnetic filed is formed between the power receiving portion and the power transmitting portion and that oscillates at a predetermined frequency. The electric field is formed between the power receiving portion and the power transmitting portion and that oscillates at a predetermined frequency.

Yet another aspect of the invention provides a power transfer system that includes: a power transmitting device that includes a power transmitting portion; and a power receiving device that includes a power receiving portion that contactlessly receives electric power from the power transmitting portion. The power receiving portion has a coil and a shield member that is arranged at a position such that the shield member faces the coil. At least one portion of the shield member is electrically cut off.

In the power transfer system, the shield member may form a tubular member that accommodates the coil inside and that has both end portions.

In the power transfer system, the tubular member may have a hole that communicates an outside of the tubular member with the inside of the tubular member.

In the power transfer system, the coil may be arranged on a first insulating member, the shield member may include a first shield member and a second shield member, the first shield member may be arranged on a second insulating member, the second shield member may be arranged on a third insulating member, and the coil may be sandwiched by the first shield member and the second shield member by sandwiching the first insulating member by the second insulating member and the third insulating member.

In the power transfer system, the first insulating member, the second insulating member and the third insulating member may be insulating substrates.

With the above power transmitting device, power receiving device and power transfer system, it is possible to reduce an electric field in an electromagnetic field formed of the electric field and a magnetic field in the case where power transfer is carried out contactlessly.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a view that schematically illustrates a power transmitting device, a power receiving device and a power transfer system according to a first embodiment of the invention;

FIG. 2 is a view that shows a simulation model of the power transfer system according to the first embodiment of the invention;

FIG. 3 is a graph that shows simulation results of the simulation model shown in FIG. 2;

FIG. 4 is a graph that shows the correlation between a power transfer efficiency and a frequency of current that is supplied to a resonance coil at the time when an air gap is changed in a state where a natural frequency is fixed in the simulation model shown in FIG. 2;

FIG. 5 is a graph that shows the correlation between a distance from a current source (magnetic current source) and a strength of an electromagnetic field in the simulation model shown in FIG. 2;

FIG. 6 is a schematic view that shows the configuration of the power transfer system according to the first embodiment of the invention;

FIG. 7 is a cross-sectional view taken along the line VII-VII in FIG. 6;

FIG. 8 is a schematic view that shows a temporal change of a power transmitting-side current value and a temporal change of a power transmitting-side stored charge according to the first embodiment of the invention;

FIG. 9 is a schematic view that shows the principle of generation of an electromagnetic field in the case where no shield member is provided and in the case where a shield member is provided in the first embodiment;

FIG. 10 is a graph that shows the correlation between a distance from a coil center and a magnetic field in the case where no shield member is provided and the case where the shield member is provided in the first embodiment;

FIG. 11 is a graph that shows the correlation between a distance from the coil center and an electric field in the case where no shield member is provided and the case where the shield member is provided in the first embodiment;

FIG. 12 is a graph that shows the correlation between a frequency and a transfer efficiency in the case where no shield member is provided and the case where the shield member is provided in the first embodiment;

FIG. 13 is a schematic view that shows the schematic configuration of a power transfer system according to an alternative embodiment to the first embodiment of the invention;

FIG. 14 is a schematic view that shows the schematic configuration of the power transfer system according to the first embodiment of the invention;

FIG. 15 is a schematic view that shows the structure of a shield member according to a second embodiment of the invention;

FIG. 16 is a schematic view that shows the structure of shield members according to a third embodiment of the invention;

FIG. 17 is an exploded perspective view that shows the structure of each shield member shown in FIG. 16; and

FIG. 18 is a schematic view that shows the structure of each shield member according to a fourth embodiment of the invention.

### DETAILED DESCRIPTION OF EMBODIMENTS

Hereinafter, a power transmitting device, a power receiving device and a power transfer system according to embodiments of the invention will be described with reference to the accompanying drawings. In the following embodiments, when the number, the amount, and the like, are referred to, the scope of the invention is not limited to those number, amount, and the like, unless otherwise specified. Like reference numerals denote the same or corresponding components, and the overlap description may not be repeated. The scope of the invention also encompasses a combination of the components described in the respective embodiments where appropriate.

A power transfer system according to the first embodiment will be described with reference to FIG. 1. FIG. 1 is a view that schematically illustrates the power transmitting device, the power receiving device and the power transfer system according to the first embodiment.

The power transfer system according to the first embodiment includes an electromotive vehicle 10 and an external power supply device 20. The electromotive vehicle 10 includes the power receiving device 40. The external power supply device 20 includes the power transmitting device 41. When the electromotive vehicle 10 is stopped at a predetermined position of a parking space 42 in which the power transmitting device 41 is provided, the power receiving device 40 of the electromotive vehicle 10 receives electric power from the power transmitting device 41.

A wheel block or a line that indicates a parking position and a parking area is provided in the parking space 42 so that the electromotive vehicle 10 is stopped at a predetermined position.

The external power supply device 20 includes a high-frequency power driver 22, a control unit 26 and the power transmitting device 41. The high-frequency power driver 22 is connected to an alternating-current power supply 21. The control unit 26 executes drive control over the high-frequency power driver 22, and the like. The power transmitting device 41 is connected to the high-frequency power driver 22. The power transmitting device 41 includes a power transmitting portion 28 and an electromagnetic induction coil 23. The power transmitting portion 28 includes a resonance coil 24 and a capacitor 25 that is connected to the resonance coil 24. The electromagnetic induction coil 23 is electrically connected to the high-frequency power driver 22. Note that, in the example shown in FIG. 1, the capacitor 25 is provided; however, the capacitor 25 is not necessarily an indispensable component.

The power transmitting portion 28 includes an electrical circuit that is formed of the inductance of the resonance coil 24, the stray capacitance of the resonance coil 24 and the capacitance of the capacitor 25.

The electromotive vehicle 10 includes the power receiving device 40, a rectifier 13, a DC/DC converter 14, a battery 15, a power control unit (PCU) 16, a motor unit 17 and a vehicle electronic control unit (ECU) 18. The rectifier 13 is connected to the power receiving device 40. The DC/DC converter 14 is connected to the rectifier 13. The battery 15 is connected to the DC/DC converter 14. The motor unit 17 is connected to the power control unit 16. The vehicle ECU 18 executes drive control over the DC/DC converter 14, the power control unit 16, and the like. The electromotive vehicle 10 according to the present embodiment is a hybrid vehicle that includes an engine (not shown). Instead, as long as the electromotive vehicle 10 is driven by a motor, the electromotive vehicle 10 may be an electric vehicle or a fuel cell vehicle.

The rectifier 13 is connected to an electromagnetic induction coil 12, converts alternating current, which is supplied from the electromagnetic induction coil 12, to direct current, and supplies the direct current to the DC/DC converter 14.

The DC/DC converter 14 adjusts the voltage of the direct current supplied from the rectifier 13, and supplies the adjusted voltage to the battery 15. The DC/DC converter 14 is not an indispensable component and may be omitted. In this case, by providing a matching transformer for matching impedance in the external power supply device 20 between the power transmitting device 41 and the high-frequency power driver 22, it is possible to substitute the matching transformer for the DC/DC converter 14.

The power control unit 16 includes a converter and an inverter. The converter is connected to the battery 15. The inverter is connected to the converter. The converter adjusts (steps up) direct current that is supplied from the battery 15, and supplies the adjusted direct current to the inverter. The inverter converts the direct current, which is supplied from the converter, to alternating current, and supplies the alternating current to the motor unit 17.

For example, a three-phase alternating-current motor, or the like, is employed as the motor unit 17. The motor unit 17 is driven by alternating current that is supplied from the inverter of the power control unit 16.

When the electromotive vehicle 10 is a hybrid vehicle, the electromotive vehicle 10 further includes an engine. In addition, the motor unit 17 includes a motor generator that mainly functions as a generator and a motor generator that mainly functions as an electric motor.

The power receiving device 40 includes a power receiving portion 27 and the electromagnetic induction coil 12. The power receiving portion 27 includes a resonance coil 11 and a capacitor 19. The resonance coil 11 has a stray capacitance. The power receiving portion 27 has an electrical circuit that is formed of the inductance of the resonance coil 11 and the capacitances of the resonance coil 11 and capacitor 19. The capacitor 19 is not an indispensable component and may be omitted.

In the power transfer system according to the present embodiment, the difference between the natural frequency of the power transmitting portion 28 and the natural frequency of the power receiving portion 27 is smaller than or equal to 10% of the natural frequency of the power receiving portion 27 or power transmitting portion 28. By setting the natural frequency of each of the power transmitting portion 28 and the power receiving portion 27 within the above range, it is possible to increase the power transfer efficiency. On the other hand, when the difference in natural frequency is larger than 10% of the natural frequency of the power receiving portion 27 or power transmitting portion 28, the power transfer efficiency becomes lower than 10%, so there occurs an inconvenience, such as an increase in a charging time for charging the battery 15.

Here, the natural frequency of the power transmitting portion 28, in the case where no capacitor 25 is provided, means an oscillation frequency in the case where the electrical circuit formed of the inductance of the resonance coil 24 and the capacitance of the resonance coil 24 freely oscillates. In the case where the capacitor 25 is provided, the natural frequency of the power transmitting portion 28 means an oscillation frequency in the case where the electrical circuit formed of the capacitances of the resonance coil 24 and capacitor 25 and the inductance of the resonance coil 24 freely oscillates. In the above-described electrical circuits, the natural frequency at the time when braking force and electric resistance are set to zero or substantially zero is called the resonance frequency of the power transmitting portion 28.

Similarly, the natural frequency of the power receiving portion 27, in the case where no capacitor 19 is provided, means an oscillation frequency in the case where the electrical circuit formed of the inductance of the resonance coil 11 and the capacitance of the resonance coil 11 freely oscillates. In the case where the capacitor 19 is provided, the natural frequency of the power receiving portion 27 means an oscillation frequency in the case where the electrical circuit formed of the capacitances of the resonance coil 11 and capacitor 19 and the inductance of the resonance coil 11 freely oscillates. In the above-described electrical circuits, the natural frequency at the time when braking force and electric resistance are set to zero or substantially zero is called the resonance frequency of the power receiving portion 27.

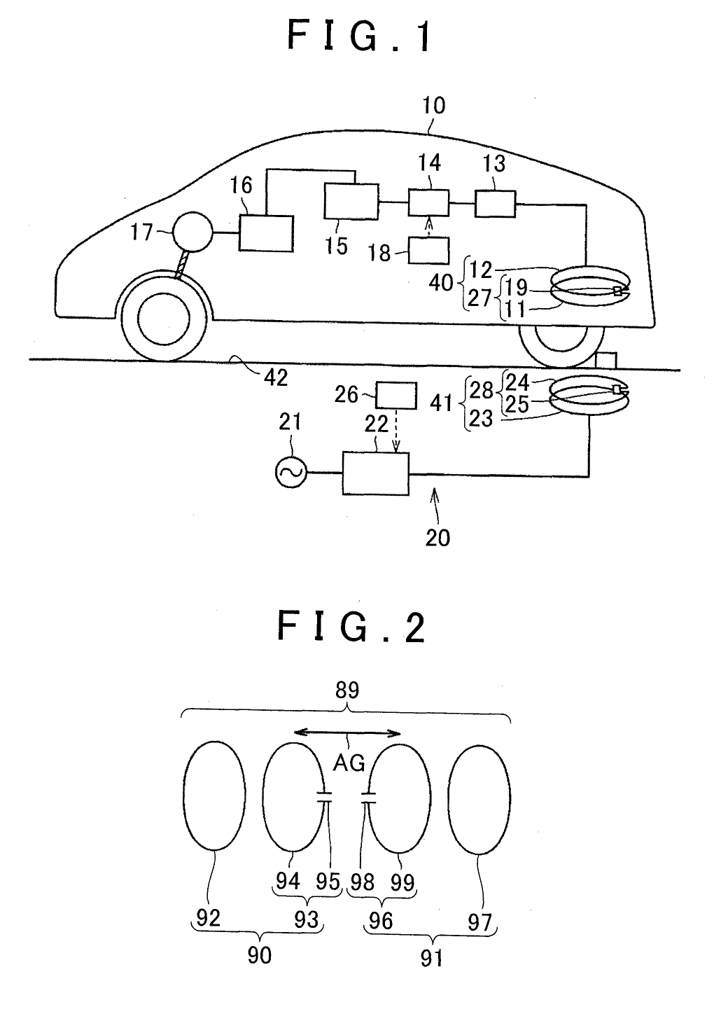

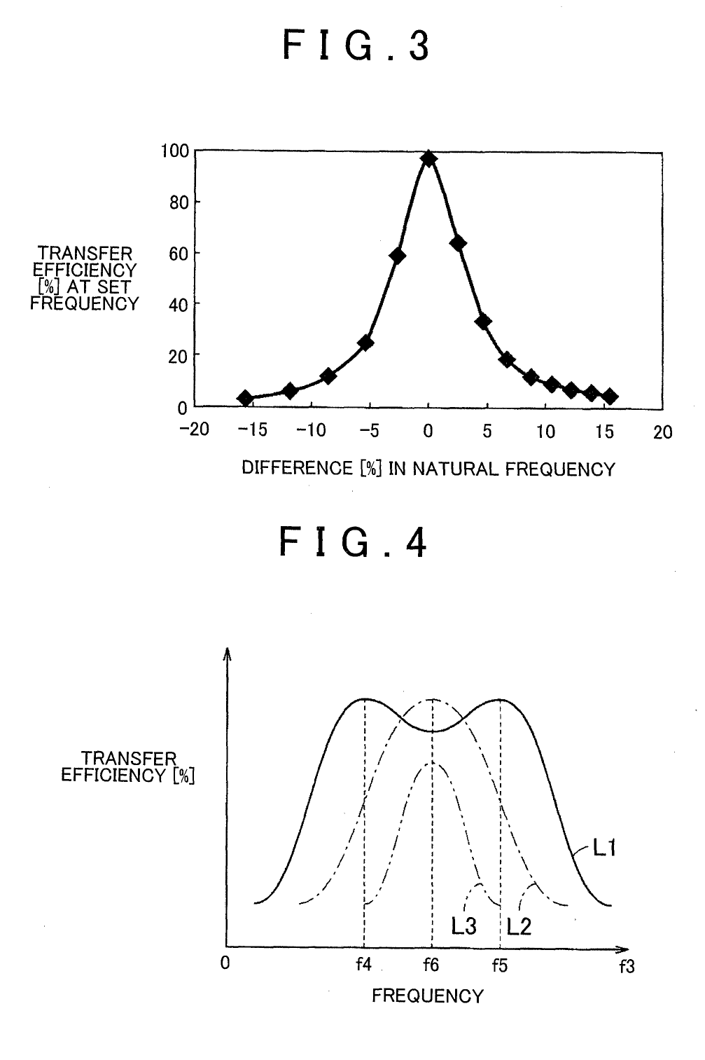

Results of simulation that analyzes the correlation between a difference in natural frequency and a power transfer efficiency will be described with reference to FIG. 2 and FIG. 3. FIG. 2 shows a simulation model of a power transfer system. The power transfer system 89 includes a power transmitting device 90 and a power receiving device 91. The power transmitting device 90 includes an electromagnetic induction coil 92 and a power transmitting portion 93. The power transmitting portion 93 includes a resonance coil 94 and a capacitor 95 provided in the resonance coil 94.

The power receiving device 91 includes a power receiving portion 96 and an electromagnetic induction coil 97. The power receiving portion 96 includes a resonance coil 99 and a capacitor 98 connected to the resonance coil 99.

The inductance of the resonance coil 94 is set to Lt, and the capacitance of the capacitor 95 is set to C1. The inductance of the resonance coil 99 is set to Lr, and the capacitance of the capacitor 98 is set to C2. When the parameters are set in this way, the natural frequency f1 of the power transmitting portion 93 is expressed by the following mathematical expression (1), and the natural frequency f2 of the power receiving portion 96 is expressed by the following mathematical expression (2).

f1=1/{2π(Lt×C1)^{1/2}} (1)

f2=1/{2π(Lr×C2)^{1/2}} (2)

Here, in the case where the inductance Lr and the capacitances C1 and C2 are fixed and only the inductance Lt is varied, the correlation between a difference in natural frequency between the power transmitting portion 93 and the power receiving portion 96 and a power transfer efficiency is shown in FIG. 3. Note that, in this simulation, a relative positional relationship between the resonance coil 94 and the resonance coil 99 is fixed, and, furthermore, the frequency of current that is supplied to the power transmitting portion 93 is constant.

As shown in FIG. 3, the abscissa axis represents a difference (%) in natural frequency, and the ordinate axis represents a transfer efficiency (%) at a set frequency. The difference (%) in natural frequency is expressed by the following mathematical expression (3).

Difference (%) in Natural Frequency={(f1−f2)/f2}×100 (3)

As is apparent from FIG. 3, when the difference (%) in natural frequency is ±0%, the power transfer efficiency is close to 100%. When the difference (%) in natural frequency is ±5%, the power transfer efficiency is 40%. When the difference (%) in natural frequency is ±10%, the power transfer efficiency is 10%. When the difference (%) in natural frequency is ±15%, the power transfer efficiency is 5%. That is, it is found that, by setting the natural frequency of each of the power transmitting portion and power receiving portion such that the absolute value of the difference (%) in natural frequency (difference in natural frequency) falls at or below 10% of the natural frequency of the power receiving portion 96, it is possible to increase the power transfer efficiency. Furthermore, it is found that, by setting the natural frequency of each of the power transmitting portion and power receiving portion such that the absolute value of the difference (%) in natural frequency is smaller than or equal to 5% of the natural frequency of the power receiving portion 96, it is possible to further increase the power transfer efficiency. Note that the electromagnetic field analyzation software application (JMAG (trademark): produced by JSOL Corporation) is employed as a simulation software application.

Next, the operation of the power transfer system according to the present embodiment will be described. As shown in FIG. 1, alternating-current power is supplied from the high-frequency power driver 22 to the electromagnetic induction coil 23. When a predetermined alternating current flows through the electromagnetic induction coil 23, alternating current also flows through the resonance coil 24 due to electromagnetic induction. At this time, electric power is supplied to the electromagnetic induction coil 23 such that the frequency of alternating current flowing through the resonance coil 24 becomes a predetermined frequency.

When current having the predetermined frequency flows through the resonance coil 24, an electromagnetic field that oscillates at the predetermined frequency is formed around the resonance coil 24.

The resonance coil 11 is arranged within a predetermined range from the resonance coil 24. The resonance coil 11 receives electric power from the electromagnetic field formed around the resonance coil 24.

In the present embodiment, a so-called helical coil is employed as each of the resonance coil 11 and the resonance coil 24. Therefore, a magnetic field that oscillates at the predetermined frequency is mainly formed around the resonance coil 24, and the resonance coil 11 receives electric power from the magnetic field.

Here, the magnetic field having the predetermined frequency, formed around the resonance coil 24, will be described. The “magnetic field having the predetermined frequency” typically correlates with the power transfer efficiency and the frequency of current that is supplied to the resonance coil 24. Then, first, the correlation between the power transfer efficiency and the frequency of current that is supplied to the resonance coil 24 will be described. The power transfer efficiency at the time when electric power is transferred from the resonance coil 24 to the resonance coil 11 varies depending on various factors, such as a distance between the resonance coil 24 and the resonance coil 11. For example, the natural frequency (resonance frequency) of the power transmitting portion 28 and power receiving portion 27 is set to f0, the frequency of current supplied to the resonance coil 24 is f3, and the air gap between the resonance coil 11 and the resonance coil 24 is set to AG.

FIG. 4 is a graph that shows the correlation between a power transfer efficiency and the frequency f3 of current that is supplied to the resonance coil 24 at the time when the air gap AG is varied in a state where the natural frequency f0 is fixed.

In the graph shown in FIG. 4, the abscissa axis represents the frequency f3 of current that is supplied to the resonance coil 24, and the ordinate axis represents a power transfer efficiency (%). An efficiency curve L1 schematically shows the correlation between a power transfer efficiency and the frequency f3 of current that is supplied to the resonance coil 24 when the air gap AG is small. As indicated by the efficiency curve L1, when the air gap AG is small, the peak of the power transfer efficiency appears at frequencies f4 and f5 (f4<f5). When the air gap AG is increased, two peaks at which the power transfer efficiency is high vary so as to approach each other. Then, as indicated by an efficiency curve L2, when the air gap AG is increased to be longer than a predetermined distance, the number of the peaks of the power transfer efficiency is one, the power transfer efficiency becomes a peak when the frequency of current that is supplied to the resonance coil 24 is f6. When the air gap AG is further increased from the state of the efficiency curve L2, the peak of the power transfer efficiency reduces as indicated by an efficiency curve L3.

For example, the following first and second methods are conceivable as a method of improving the power transfer efficiency. In the first method, by varying the capacitances of the capacitor 25 and capacitor 19 in accordance with the air gap AG while the frequency of current that is supplied to the resonance coil 24 shown in FIG. 1 is constant, the characteristic of power transfer efficiency between the power transmitting portion 28 and the power receiving portion 27 is varied. Specifically, the capacitances of the capacitor 25 and capacitor 19 are adjusted such that the power transfer efficiency becomes a peak in a state where the frequency of current that is supplied to the resonance coil 24 is constant. In this method, irrespective of the size of the air gap AG, the frequency of current flowing through the resonance coil 24 and the resonance coil 11 is constant. As a method of varying the characteristic of power transfer efficiency, a method of utilizing a matching transformer provided between the power transmitting device 41 and the high-frequency-power driver 22, a method of utilizing the converter 14, or the like, may be employed.

In addition, in the second method, the frequency of current that is supplied to the resonance coil 24 is adjusted on the basis of the size of the air gap AG. For example, in FIG. 4, when the power transfer characteristic becomes the efficiency curve L1, current having the frequency f4 or the frequency f5 is supplied to the resonance coil 24. Then, when the frequency characteristic becomes the efficiency curve L2 or L3, current having the frequency f6 is supplied to the resonance coil 24. In this case, the frequency of current flowing through the resonance coil 24 and the resonance coil 11 is varied in accordance with the size of the air gap AG.

In the first method, the frequency of current flowing through the resonance coil 24 is a fixed constant frequency, and, in the second method, the frequency of current flowing through the resonance coil 24 is a frequency that appropriately varies with the air gap AG. Through the first method, the second method, or the like, current having the predetermined frequency set such that the power transfer efficiency is high is supplied to the resonance coil 24. When current having the predetermined frequency flows through the resonance coil 24, a magnetic field (electromagnetic field) that oscillates at the predetermined frequency is formed around the resonance coil 24. The power receiving portion 27 receives electric power from the power transmitting portion 28 through the magnetic field that is formed between the power receiving portion 27 and the power transmitting portion 28 and that oscillates at the predetermined frequency. Thus, the “magnetic field that oscillates at the predetermined frequency” is not necessarily a magnetic field having a fixed frequency. Note that, in the above-described embodiment, the frequency of current that is supplied to the resonance coil 24 is set by focusing on the air gap AG; however, the power transfer efficiency also varies on the basis of other factors, such as a deviation in the horizontal direction between the resonance coil 24 and the resonance coil 11, so the frequency of current that is supplied to the resonance coil 24 may possibly be adjusted on the basis of those other factors.

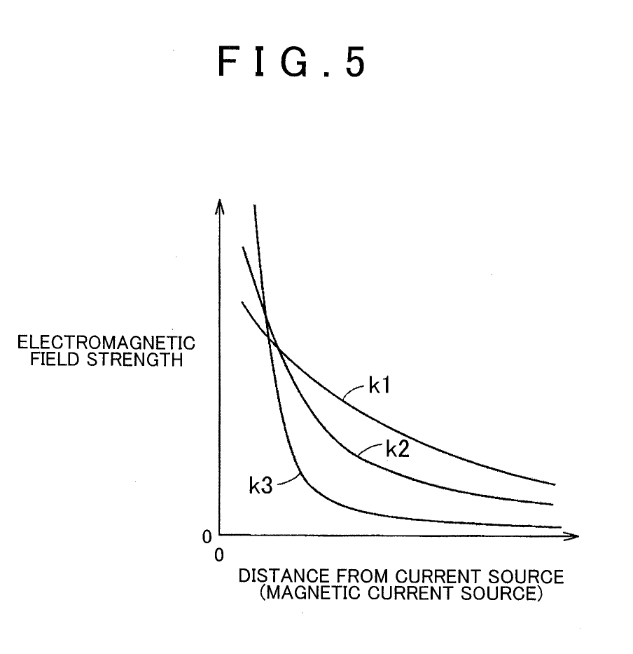

In the power transfer system according to the present embodiment, a near field (evanescent field) in which the electrostatic field or static electromagnetic field of an electromagnetic field is dominant is utilized. By so doing, power transmitting and power receiving efficiencies are improved. FIG. 5 is a graph that shows the correlation between a distance from a current source (magnetic current source) and a strength of an electromagnetic field. As shown in FIG. 5, the electromagnetic field includes three components. A curve k1 is a component inversely proportional to a distance from a wave source, and is referred to as radiation field or radiation electromagnetic field. A curve k2 is a component inversely proportional to the square of a distance from a wave source, and is referred to as induction field or induction electromagnetic field. In addition, a curve k3 is a component inversely proportional to the cube of a distance from a wave source, and is referred to as electrostatic field or static electromagnetic field. Where the wavelength of the electromagnetic field is λ, a distance at which the strengths of the radiation field or radiation electromagnetic field, induction field or induction electromagnetic field and electrostatic field or static electromagnetic field are substantially equal to one another may be expressed as λ/2π.

The electrostatic field is a region in which the strength of electromagnetic wave steeply reduces with a distance from a wave source. In the power transfer system according to the present embodiment, transfer of energy (electric power) is performed by utilizing the near field (evanescent field) in which the electrostatic field is dominant. That is, by resonating the power transmitting portion 28 and the power receiving portion 27 (for example, a pair of LC resonance coils) respectively having close natural frequencies in the near field in which the electrostatic field is dominant, energy (electric power) is transferred from the power transmitting portion 28 to the power receiving portion 27. This electrostatic field does not propagate energy to a far place. Thus, in comparison with an electromagnetic wave that transfers energy (electric power) by the radiation field that propagates energy to a far place, the resonance method is able to transmit electric power with a less energy loss.

In this way, in the power transfer system according to the present embodiment, by resonating the power transmitting portion 28 and the power receiving portion 27 through the electromagnetic field, electric power is transmitted from the power transmitting device 41 to the power receiving device 40. Then, a coupling coefficient κ between the power transmitting portion 28 and the power receiving portion 27 is smaller than or equal to 0.1. Generally, in power transfer that utilizes electromagnetic induction, the coupling coefficient κ between the power transmitting portion and the power receiving portion is close to 1.0.

Coupling between the power transmitting portion 28 and the power receiving portion 27 in power transfer according to the present embodiment is, for example, called “magnetic resonance coupling”, “magnetic field resonance coupling”, “electromagnetic field resonance coupling” or “electric field resonance coupling”.

The electromagnetic field resonance coupling means coupling that includes the magnetic resonance coupling, the magnetic field resonance coupling and the electric field resonance coupling.

Coil-shaped antennas are employed as the resonance coil 24 of the power transmitting portion 28 and the resonance coil 11 of the power receiving portion 27, described in the specification. Therefore, the power transmitting portion 28 and the power receiving portion 27 are mainly coupled through a magnetic field, and the power transmitting portion 28 and the power receiving portion 27 are coupled through magnetic resonance or magnetic field resonance.

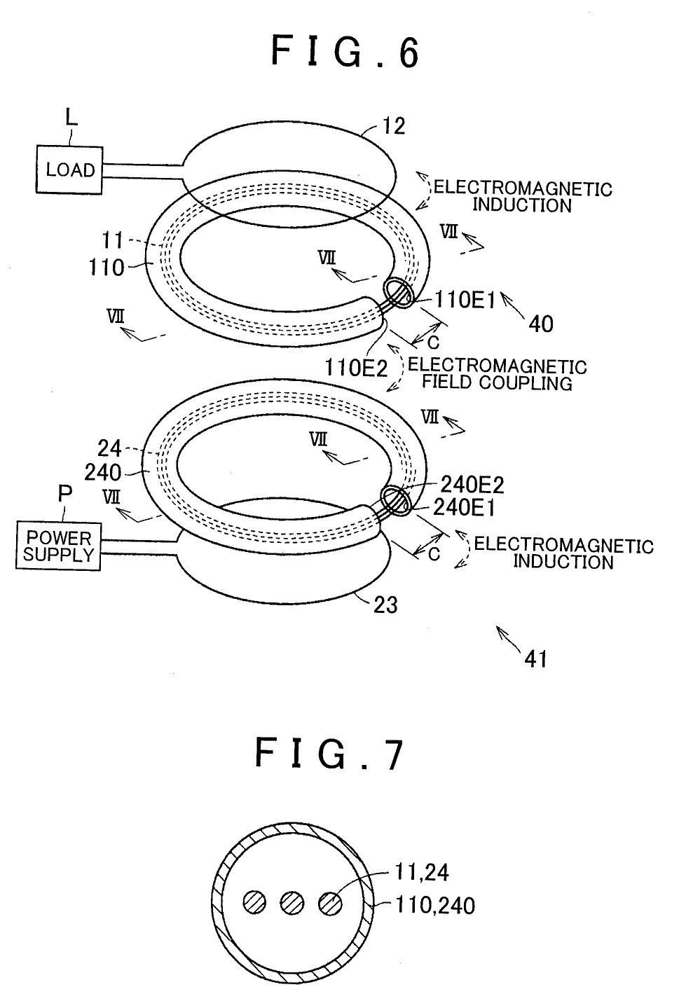

The configuration of shield members according to the present embodiment will be described with reference to FIG. 6 and FIG. 7. FIG. 6 is a schematic view that shows the configuration of the power transfer system. FIG. 7 is a cross-sectional view taken along the line VII-VII in FIG. 6.

The power transmitting device 41 includes the resonance coil 24 and the electromagnetic induction coil 23. A power supply P is connected to the electromagnetic induction coil 23. The resonance coil 24 is accommodated in a tubular member 240 that serves as a shield member. The tubular member 240 has an annular shape along the shape of the resonance coil 24. The tubular member 240 has an end portion 240E1 and an end portion 240E2.

The end portion 240E1 and the end portion 240E2 are arranged so as to face each other with a predetermined clearance C. With the clearance C, the tubular member 240 is electrically cut off. By so doing, current does not flow through the tubular member 240 annularly. The clearance C is not limited to one. Two or more clearances C may be provided. The resonance coil 24 is accommodated inside the tubular member 240 so as not to be in contact with the tubular member 240 with the use of a resin support member (not shown), or the like. The clearance C is not limited to one. A plurality of the clearances C may be provided.

The tubular member 240 is basically formed of a shield material made of a conductor. For example, a metal material, such as a hollow copper, is used. Alternatively, the tubular member 240 may be formed of a hollow tubular member from a low-cost member with a copper foil or a cloth, a sponge, or the like, having an electromagnetic wave shielding effect being stuck to the inner surface of the tubular member.

The power receiving device 40 includes the resonance coil 11 and the electromagnetic induction coil 12. A load L is connected to the electromagnetic induction coil 12. The resonance coil 11 is accommodated in a tubular member 110 that serves as a shield member. The tubular member 110 has an annular shape along the shape of the resonance coil 11. The tubular member 110 has an end portion 110E1 and 0.15 an end portion 110E2. The end portion 110E1 and the end portion 110E2 are arranged so as to face each other with a predetermined clearance C. With the clearance C, the tubular member 110 is electrically cut off. By so doing, current does not flow through the tubular member 110 annularly. The clearance C is not limited to one. Two or more clearances C may be provided. The resonance coil 11 is accommodated inside the tubular member 110 so as not to be electrically in contact with the tubular member 110 with the use of a resin support member (not shown), or the like.

In the above description, shielding means a function of, when an electromagnetic field has reached a target object, inhibiting a travel of the electromagnetic wave across the target object, and specifically means inhibiting a travel of an electromagnetic wave by converting an incoming electromagnetic wave to an eddy current.

When electric power that is supplied from the power supply P to the power transmitting device 41 is transferred from the power transmitting device 41 to the power receiving device 40, electromagnetic induction occurs between the electromagnetic induction coil 23 and the resonance coil 24 in the power transmitting device 41. Electromagnetic coupling occurs between the resonance coil 24 of the power transmitting device 41 and the resonance coil 11 of the power receiving device 40. Electromagnetic induction occurs between the resonance coil 11 and the electromagnetic induction coil 12 in the power receiving device 40. By so doing, power transfer from the power transmitting device 41 to the power receiving device 40 is carried out.

Note that the shape of each of the electromagnetic induction coils 12 and 23 and the resonance coils 11 and 24 is just an example and is not always limited to an annular shape.

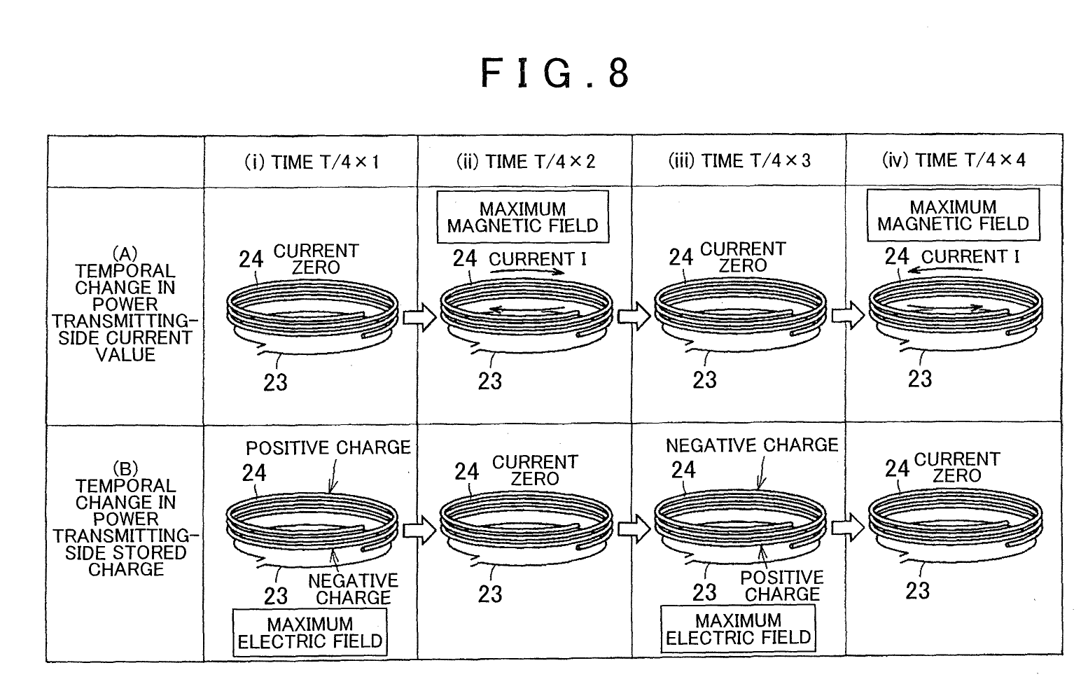

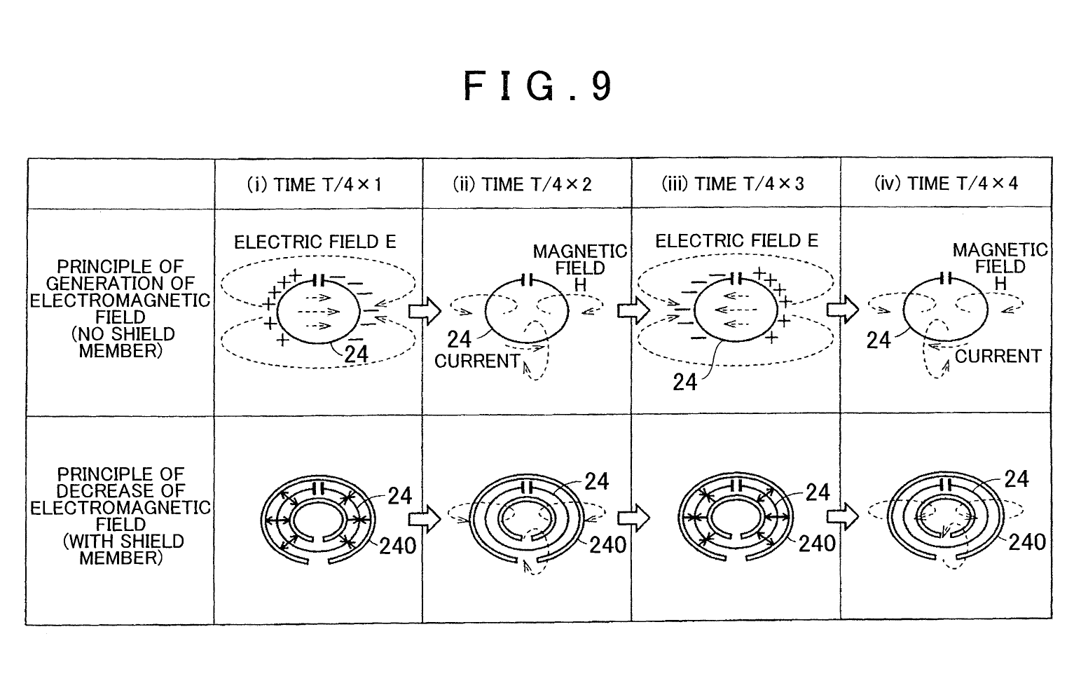

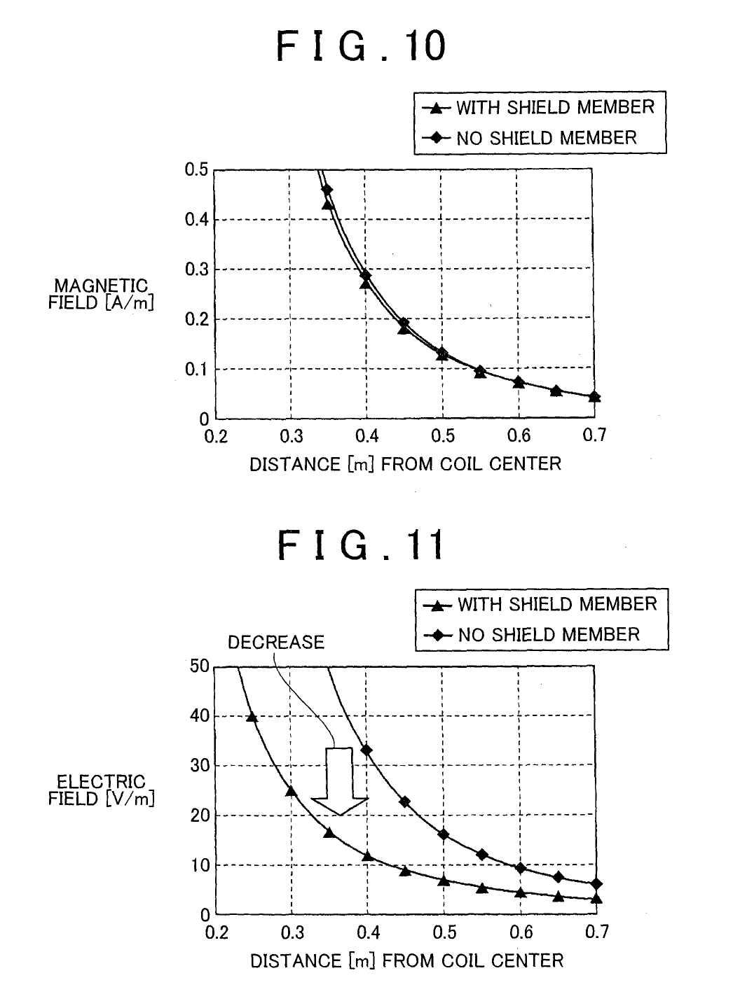

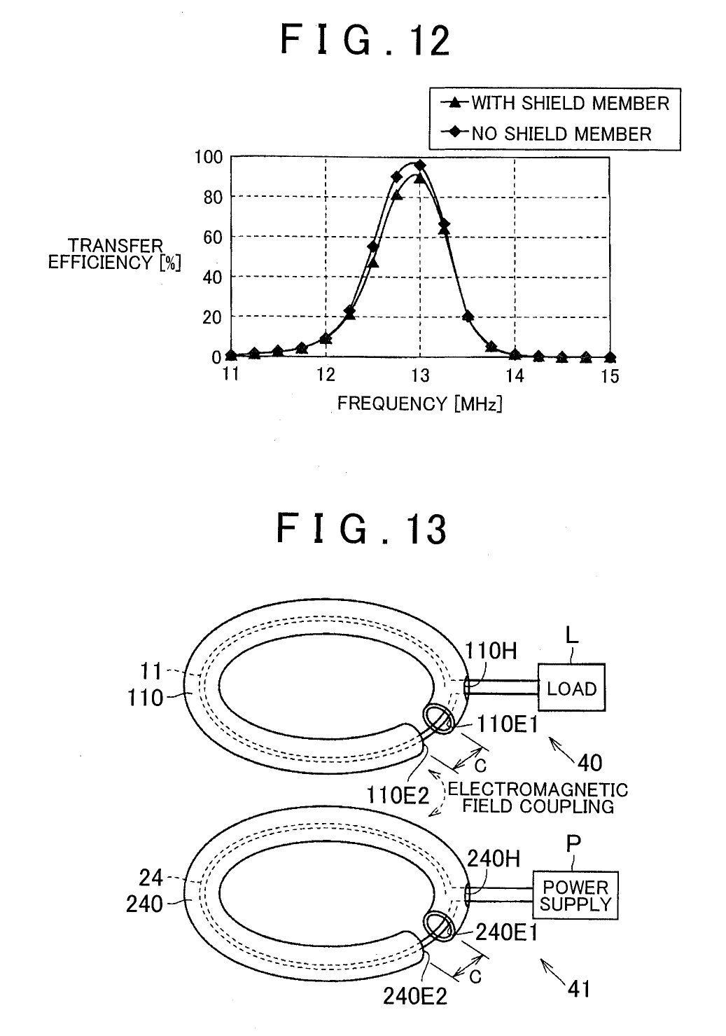

Here, the operation and advantageous effects of the tubular members 110 and 240 that serve as the shield members according to the present embodiment will be described with reference to FIG. 8 to FIG. 12. FIG. 8 is a schematic view that shows a temporal change of a power transmitting-side current value and a temporal change of a power transmitting-side stored charge. FIG. 9 is a schematic view that shows the principle of generation of an electromagnetic field in the case where no shield member is provided and in the case where a shield member is provided. FIG. 10 is a graph that shows the correlation between a distance from a coil center and a magnetic field in the case where no shield member is provided and the case where the shield member is provided. FIG. 11 is a graph that shows the correlation between a distance from the coil center and an electric field in the case where no shield member is provided and the case where the shield member is provided. FIG. 12 is a graph that shows the correlation between a frequency and a transfer efficiency in the case where no shield member is provided and the case where the shield member is provided.

As shown in FIG. 8, a temporal change of current value at the time of electromagnetic field resonance in the case where an alternating-current sinusoidal wave having a period of T seconds is applied to the power transmitting side is, as shown at (A) “Temporal Change of Power Transmitting-side Current Value” (top row), (i) zero-current at time T/4×1, (ii) I-current (clockwise direction) at time T/4×2, (iii) zero-current at time T/4×3 and (iv) I-current (counterclockwise direction) at time T/4×4. In this way, the zero-current state and the I-current state alternately change at a period of T/4. At this time, a generated magnetic field at the power transmitting device side is maximum at (ii) time T/4×2 and at (iv) time T/4×4.

On the other hand, a temporal change of stored charge at the time of electromagnetic field resonance in the case where an alternating-current sinusoidal wave having a period of T seconds is applied to the power transmitting side is, as shown at (B) “Temporal Change of Power Transmitting-side Stored Charge” (bottom row), (i) positive charge is stored at the upper side and negative charge is stored at the lower side in the drawing of the resonance coil 24 at time T/4×1, (ii) charge is zero at time T/4×2, (iii) negative charge is stored at the upper side and positive charge is stored at the lower side in the drawing of the resonance coil 24 at time T/4×3, and (iv) charge is zero at time T/4×4. In this way, the charge storage state and the zero-charge state alternately change at a period of T/4. At this time, a generated electric field at the power transmitting device side is maximum at (i) time T/4×1 and at (iii) time T/4×3.

That is, the electric field is maximum at (i) time T/4×1, the magnetic field is maximum at (ii) time T/4×2, the electric field is maximum at (iii) time T/4×3, and the magnetic field is maximum at (iv) time T/4×4.

In this way, the maximum electric field and the maximum magnetic field alternately appear, and the energy of electric field and the energy of magnetic field are alternately stored in the resonance coil 24.

Next, by making a comparison with the case where no shield member is provided in the present embodiment with reference to FIG. 9, the principle of generation of an electromagnetic field in the case where the shield member is provided according to the present embodiment will be described. As shown in FIG. 8, with the result that the energy of electric field and the energy of magnetic field are alternately stored in the resonance coil 24, an electric field E and a magnetic field H alternately appear in the resonance coil 24 at a period of the time T/4 as shown in the top row in FIG. 9.

When the resonance coil 24 is accommodated inside the tubular member 240 that is the shield member according to the present embodiment, the electric field is enclosed inside the tubular member 240 made of a conductor, and radiation of the electric field to the outside of the tubular member 240 is remarkably reduced.

On the other hand, the magnetic field H occurs around the coil wire of the resonance coil 24. The tubular member 240 does not have a complete annular shape. The tubular member 240 has the clearance C such that the end portion 240E1 and the end portion 240E2 face each other. Therefore, current that cancels current that is generated in the resonance coil 24 does not flow through the tubular member 240.

As a result, as shown at the bottom row in FIG. 9, the electric field is enclosed by the tubular member 240, and the magnetic field is radiated to the outside of the tubular member 240 without receiving influence from the tubular member 240.

A change in magnetic field and a change in electric field in the case where the tubular member 240 is provided will be described with reference to FIG. 10 and FIG. 11. As shown in FIG. 10, even when the tubular member 240 is provided, a magnetic field just slightly decreases. On the other hand, as shown in FIG. 11, it appears that, when the tubular member 240 is provided, an electric field decreases by a large amount.

In the above description, the operation and advantageous effects in the case where the tubular member 240 is provided in the resonance coil 24 of the power transmitting device 41 are described; however, similar operation and advantageous effects are obtained in the case where the tubular member 110 is provided in the resonance coil 11 of the power receiving device 40.

A transfer efficiency in the case where the tubular member 240 is provided in the resonance coil 24 of the power transmitting device 41 and the tubular member 110 is provided in the resonance coil 11 of the power receiving device 40 will be described. As shown in the graph, it is possible to keep a high transfer efficiency even when the tubular member is provided in each of the resonance coils without significantly receiving influence of the presence or absence of each of the tubular members 110 and 240.

When the tubular member is provided in any one of the resonance coil 24 of the power transmitting device 41 and the resonance coil 11 of the power receiving device 40 as well, it is possible to reduce an electric field component in a state where the transfer efficiency is kept.

In this way, in the present embodiment, by employing the structure that the resonance coil is accommodated inside the tubular member that serves as the shield member, it is possible to reduce an electric field component in an electromagnetic field formed of the electric field component and a magnetic field component in the case where power transfer is carried out contactlessly.

The tubular member according to the present embodiment is just one example configuration that a shield member is arranged at a position such that the shield member faces the resonance coil. As the shield member is arranged to face the coil, a tubular shape is formed.

In the above-described embodiment, the description is made on the case where the power supply P is connected to the electromagnetic induction coil 23 of the power transmitting device 41 and the load L is connected to the electromagnetic induction coil 12 of the power receiving device 40; however, it is not limited to this configuration. As shown in FIG. 13 as an alternative embodiment to the first embodiment, the power supply P may be connected to the resonance coil 24 of the power transmitting device 41, and the load L may be connected to the resonance coil 11 of the power receiving device 40.

In this case, when the power supply P is connected to the resonance coil 24, an opening 240H is formed in the tubular member 240, and wiring is performed such that a wire does not contact the tubular member 240 that defines the opening 240H. Similarly, when the load L is connected to the resonance coil 11, an opening 110H is formed in the tubular member 110, and wiring is performed such that a wire does not contact the tubular member 110 that defines the opening 110H.

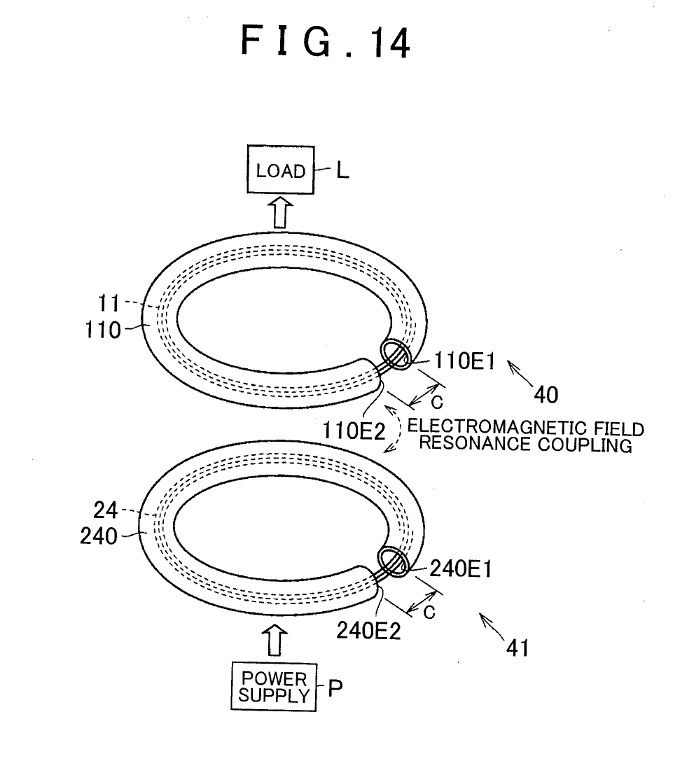

As shown in FIG. 14, the invention has such a feature that a shield member is arranged at a position such that the shield member faces a resonance coil, and a mode in which the power supply P is connected to the power transmitting device 41 and a mode in which the load L is connected to the power receiving device 40 may be any mode. The same applies to the cases where a shield member according to the following alternative embodiments are employed.

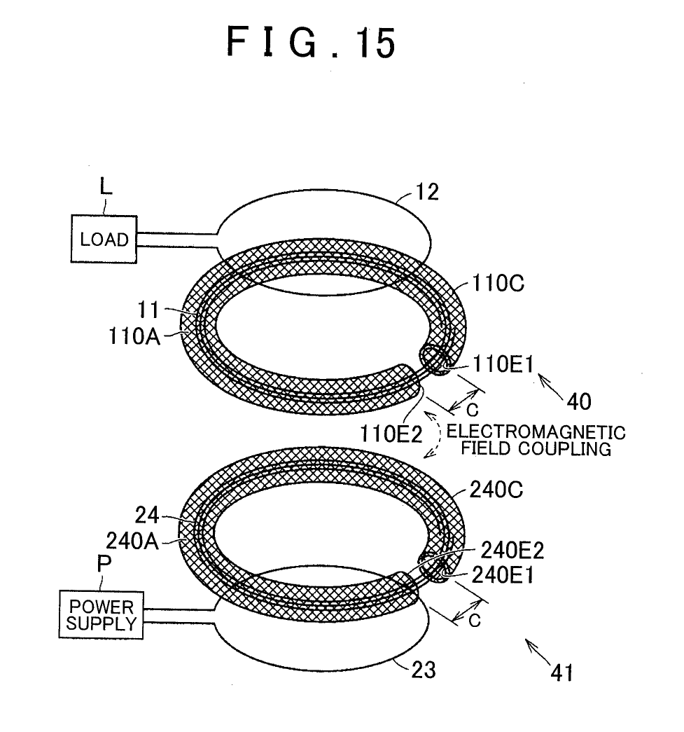

Tubular members 110A and 240A that are formed of a braided member having electrical conductivity as tubular members that are respectively used in the power transmitting device 41 and the power receiving device 40 according to a second embodiment of the invention will be described with reference to FIG. 15. As a transferred electric power increases in contactless power transfer, current values that respectively flow through the electromagnetic induction coils 12 and 23 and the resonance coils 11 and 24 increase.

The electromagnetic induction coils 12 and 23 and the resonance coils 11 and 24 have resistance characteristics, so the electromagnetic induction coils 12 and 23 and the resonance coils 11 and 24 generate heat. As described in the above embodiment, when each coil is accommodated inside the corresponding tubular member, heat is accumulated inside the tubular member.

Then, as shown in FIG. 15, by forming the tubular members 110A and 240A from braided members respectively having a plurality of holes 110C and 240C, it is possible to release heat, which is generated inside the tubular members 110A and 240A, to the outside of the tubular members 110A and 240A. In addition, by forming the tubular members 110A and 240A from the braided members, it is possible to reduce the weight of each of the power transmitting device 41 and the power receiving device 40. The material of each braided member may be a material similar to those of the tubular members 110 and 240 according to the above-described embodiment.

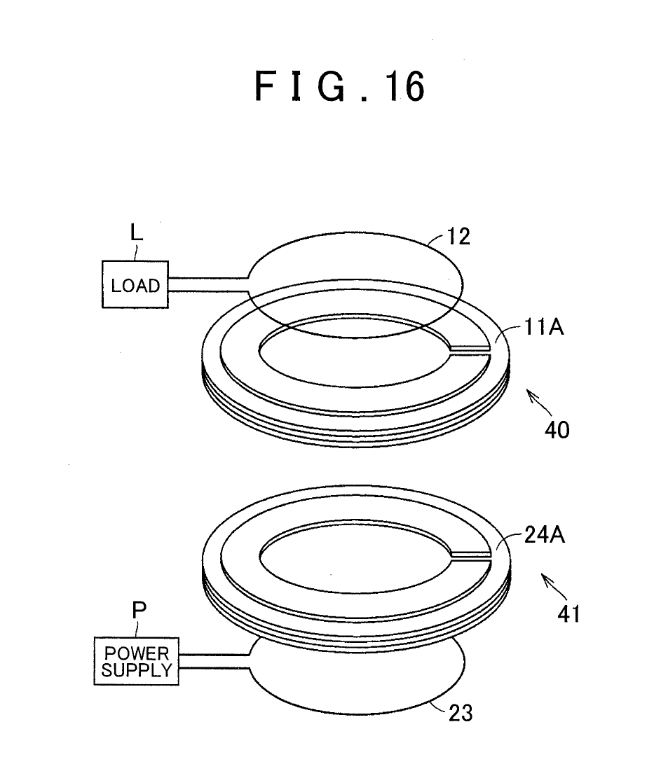

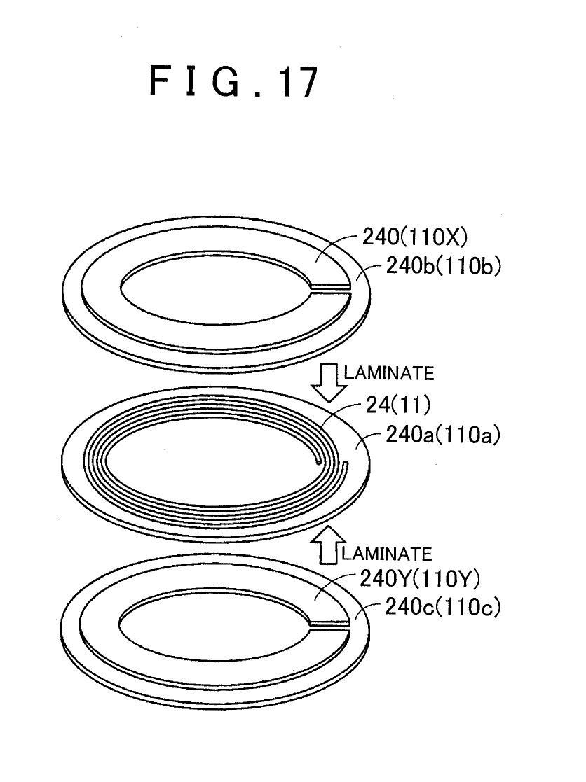

A resonance coil assembly 24A that is used in the power transmitting device 41 and a resonance coil assembly 11A that is used in the power receiving device 40 according to a third embodiment of the invention will be described with reference to FIG. 16 and FIG. 17. As shown in FIG. 16, the resonance coil assembly 11A and the resonance coil assembly 24A each have a disc shape.

FIG. 17 shows an example configuration of each of the resonance coil assembly 11A and the resonance coil assembly 24A. The resonance coil assembly 11A and the resonance coil assembly 24A have the same structure, so the structure of the resonance coil assembly 24A will be described. The reference numerals in parentheses in FIG. 17 indicate those in the case of the resonance coil assembly 11A.

The resonance coil 24 is arranged on a first insulating substrate 240a made of resin. In the drawing, a second insulating substrate 240b made of resin is located above the first insulating substrate 240a, and a first shield member 240X is arranged on the second insulating substrate 240b. In the drawing, a third insulating substrate 240c made of resin is located below the first insulating substrate 240a, and a second shield member 240Y is arranged on the third insulating substrate 240c.

The first shield member 240X and the second shield member 240Y each are formed of a metal layer having an annular shape with a predetermined width so as to be able to sandwich the resonance coil 24 from both upper and lower sides.

The first insulating substrate 240a is sandwiched by the second insulating substrate 240b and the third insulating substrate 240c, and the first insulating substrate 240a, the second insulating substrate 240b and the third insulating substrate 240c are fixed together by an adhesive, or the like. By so doing, the state where the resonance coil 24 is sandwiched by the first shield member 240X and the second shield member 240Y is maintained.

In this way, by using insulating substrates made of resin, it is possible to easily arrange the first shield member 240X and the second shield member 240Y at positions such that the first shield member 240X and the second shield member 240Y face each other via the resonance coil 24. With this configuration as well, when power transfer is performed contactlessly, it is possible to reduce an electric field component in an electromagnetic field formed of the electric field component and a magnetic field component.

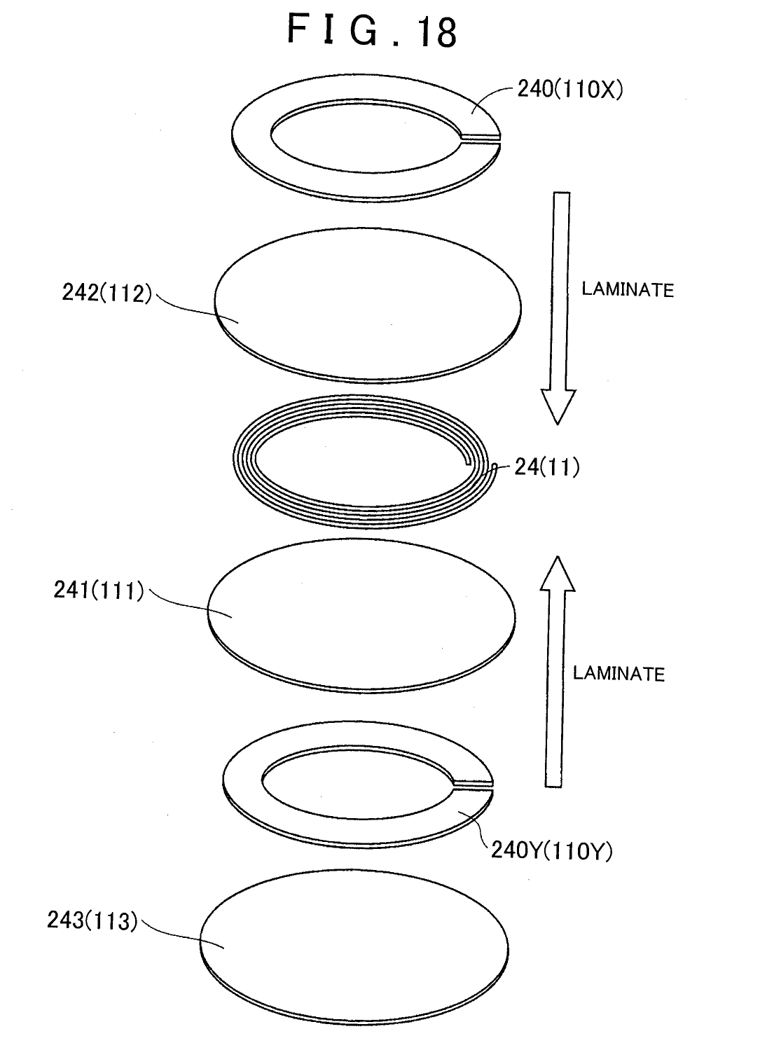

Although not limited to the configuration that uses the insulating substrates shown in FIG. 17, insulating papers may be used as the insulating members in place of the insulating substrates as shown in FIG. 18 as a fourth embodiment of the invention.

The resonance coil 24 is arranged on a first insulating paper 241 made of paper. In the drawing, a second insulating paper 242 made of paper is located above the first insulating paper 241, and the first shield member 240X is arranged on the second insulating paper 242. In the drawing, a third insulating paper 243 made of paper is located below the first insulating paper 241, and the second shield member 240Y is arranged on the third insulating paper 243.

The first shield member 240X and the second shield member 240Y each are formed of a metal layer having an annular shape with a predetermined width so as to be able to sandwich the resonance coil 24 from both upper and lower sides.

The first insulating paper 241 is sandwiched by the second insulating paper 242 and the third insulating paper 243, and the first insulating paper 241, the second insulating paper 242 and the third insulating paper 243 are fixed together by an adhesive, or the like. By so doing, the state where the resonance coil 24 is sandwiched by the first shield member 240X and the second shield member 240Y is maintained.

In this way, by using insulating papers made of paper, it is possible to easily arrange the first shield member 240X and the second shield member 240Y at positions such that the first shield member 240X and the second shield member 240Y face each other via the resonance coil 24. With this configuration as well, when power transfer is performed contactlessly, it is possible to reduce an electric field component in an electromagnetic field formed of the electric field component and a magnetic field component.

The embodiments described above are illustrative and not restrictive in all respects. The scope of the invention is defined by not the above description but the appended claims. The scope of the invention is intended to encompass all modifications within the scope of the appended claims and equivalents thereof.

1. A power transmitting device comprising:
a power transmitting portion that has a coil and a shield member and that contactlessly transmits electric power to a power receiving portion, the shield member being arranged at a position such that the shield member faces the coil, and at least one portion of the shield member being electrically cut off.

2. The power transmitting device according to claim 1, wherein
the shield member forms a tubular member that accommodates the coil inside and that has both end portions.

3. The power transmitting device according to claim 2, wherein
the tubular member has a hole that communicates an outside of the tubular member with the inside of the tubular member.

4. The power transmitting device according to claim 1, wherein
the coil is arranged on a first insulating member,
the shield member includes a first shield member and a second shield member,
the first shield member is arranged on a second insulating member,
the second shield member is arranged on a third insulating member, and
the coil is sandwiched by the first shield member and the second shield member by sandwiching the first insulating member by the second insulating member and the third insulating member.

5. The power transmitting device according to claim 4, wherein
the first insulating member, the second insulating member and the third insulating member are insulating substrates.

6. The power transmitting device according to claim 1, wherein
a difference between a natural frequency of the power transmitting portion and a natural frequency of the power receiving portion is smaller than or equal to 10% of the natural frequency of the power receiving portion.

7. The power transmitting device according to claim 1, wherein
a coupling coefficient between the power receiving portion and the power transmitting portion is smaller than or equal to 0.1.

8. The power transmitting device according to claim 1, wherein
the power transmitting portion transmits electric power to the power receiving portion through at least one of a magnetic field and an electric field, the magnetic field is formed between the power receiving portion and the power transmitting portion and oscillates at a predetermined frequency, and the electric field is formed between the power receiving portion and the power transmitting portion and oscillates at a predetermined frequency.

9. A power transfer system comprising:
a power transmitting device that includes a power transmitting portion, the power transmitting portion having a coil and a shield member, and the shield member being arranged at a position such that the shield member faces the coil, at least one portion of the shield member being electrically cut off; and
a power receiving device that includes a power receiving portion that contactlessly receives electric power from the power transmitting portion.

10. The power transfer system according to claim 9, wherein
the shield member forms a tubular member that accommodates the coil inside and that has both end portions.

11. The power transfer system according to claim 10, wherein
the tubular member has a hole that communicates an outside of the tubular member with the inside of the tubular member.

12. The power transfer system according to claim 9, wherein
the coil is arranged on a first insulating member,
the shield member includes a first shield member and a second shield member,
the first shield member is arranged on a second insulating member,
the second shield member is arranged on a third insulating member, and
the coil is sandwiched by the first shield member and the second shield member by sandwiching the first insulating member by the second insulating member and the third insulating member.

13. The power transfer system according to claim 12, wherein
the first insulating member, the second insulating member and the third insulating member are insulating substrates.

14. A power receiving device comprising:
a power receiving portion that has a coil and a shield member and that contactlessly receives electric power from a power transmitting portion, the shield member being arranged at a position such that the shield member faces the coil, and at least one portion of the shield member being electrically cut off.

15. The power receiving device according to claim 14, wherein
the shield member forms a tubular member that accommodates the coil inside and that has both end portions.

16. The power receiving device according to claim 15, wherein
the tubular member has a hole that communicates an outside of the tubular member with the inside of the tubular member.

17. The power receiving device according to claim 14, wherein
the coil is arranged on a first insulating member,
the shield member includes a first shield member and a second shield member,
the first shield member is arranged on a second insulating member,
the second shield member is arranged on a third insulating member, and
the coil is sandwiched by the first shield member and the second shield member by sandwiching the first insulating member by the second insulating member and the third insulating member.

18. The power receiving device according to claim 17, wherein
the first insulating member, the second insulating member and the third insulating member are insulating substrates.

19. The power receiving device according to claim 14, wherein
a difference between a natural frequency of the power transmitting portion and a natural frequency of the power receiving portion is smaller than or equal to 10% of the natural frequency of the power receiving portion.

20. The power receiving device according to claim 14, wherein
a coupling coefficient between the power receiving portion and the power transmitting portion is smaller than or equal to 0.1.

21. The power receiving device according to claim 14, wherein
the power transmitting portion transmits electric power to the power receiving portion through at least one of a magnetic field and an electric field, the magnetic field is formed between the power receiving portion and the power transmitting portion and oscillates at a predetermined frequency, and the electric field is formed between the power receiving portion and the power transmitting portion and oscillates at a predetermined frequency.

22. A power transfer system comprising:
a power transmitting device that includes a power transmitting portion; and
a power receiving device that includes a power receiving portion that contactlessly receives electric power from the power transmitting portion, the power receiving portion having a coil and a shield member, the shield member being arranged at a position such that the shield member faces the coil, and at least one portion of the shield member being electrically cut off.

23. The power transfer system according to claim 22, wherein
the shield member forms a tubular member that accommodates the coil inside and that has both end portions.

24. The power transfer system according to claim 23, wherein
the tubular member has a hole that communicates an outside of the tubular member with the inside of the tubular member.

25. The power transfer system according to claim 22, wherein
the coil is arranged on a first insulating member,
the shield member includes a first shield member and a second shield member,
the first shield member is arranged on a second insulating member,
the second shield member is arranged on a third insulating member, and
the coil is sandwiched by the first shield member and the second shield member by sandwiching the first insulating member by the second insulating member and the third insulating member.

26. The power transfer system according to claim 25, wherein
the first insulating member, the second insulating member and the third insulating member are insulating substrates.
